(19) United States
(12) Patent Application Publication
(10) Pub. No.: US 2004/0061599 A1
(43) Pub. Date: Apr. 1, 2004

(54) Sensor and anchoring device

(76) Inventor: Shih-Hsiung Li, Taipei (TW)

Correspondence Address: Alan D. Kamrath, Rider, Bennett, Egan & Arundel, LLP, Suite 2000, 333 South Seventh Street, Minneapolis, MN, 55402, US

(21) Appl. No.: 10/212,338

(22) Filed: Aug. 5, 2002

(51) Int. Cl. B60Q 1/00

(52) U.S. Cl. 340/435; 340/693.5

(57) ABSTRACT

A sensor and anchoring device comprises a sensor, a cylindrical jacket and a catch bracket. The sensor is fitted into the cylindrical jacket and the cylindrical jacket is inserted into the vehicle rear bumper by an appropriate means. The catch bracket for holding the sensor is then fixed on the rear bumper by an appropriate means. The present invention is characterized by the special construction of the cylindrical jacket and the catch bracket, which allows these two parts to be easily assembled and mounted onto the vehicle bumper. The length of the cylindrical jacket can be changed, if necessary, to suit different thickness specifications for the rear bumper, such that the front end of the sensor is always salient from the rear bumper, avoiding any interference with the emission and reception of signals.

### BACKGROUND OF THE INVENTION

1. Field of the Invention

The present invention relates to a sensor and anchoring device, in particular to a mechanical construction of a sensor and anchoring device that can facilitate the installation of the parking sensor on the rear bumper of a vehicle.

2. Description of Related Arts

To make a motor vehicle easier to park and avoid collisions with other cars or objects in the way, recent model vehicles are usually equipped with parking sensors at the rear end. But for older vehicles, owners have to custom install the sensors, as these were considered as non-standard accessories at the time of manufacture of the vehicle. However, in the face of increasing market demand and the needs to improve the parking precision and safety, such a parking sensor has now become a standard feature in most sedans. Such device is capable of providing the driver with an early warning if any obstacle is in the way, when the vehicle is parked along side the road or in the parking area. The device detects any possible obstacle by transmitting radar signals and receiving the same reflected from the object. The driver thus can park the car easily and avoid collision with any obstacles in the way.

Normally these parking sensors are installed on the rear bumper. Unless car manufacturers already have reserved slots in the bumper for future installation of the parking sensor, any modification of the rear bumper could affect the integral structure of the bumper and the overall safety of the vehicle. Besides, the sturdiness of the mounting and ease in installation are other considerations when one is to choose a suitable parking sensor.

### SUMMARY OF THE INVENTION

The main object of the present invention is to provide a sensor and anchoring device with a special construction that possesses the required anchor strength and facilitates the installation of the parking sensor on the rear bumper of a vehicle.

The sensor and anchoring device in accordance with the present invention comprises a sensor, a cylindrical jacket and a catch bracket; wherein

the tubular shaped sensor has a guide block on the sidewall and a signal socket attached to the fixed end;

the cylindrical jacket used to hold the sensor is to be set in the rear bumper and has a catch slot and a ring slot on the external wall; and

the catch bracket has a mouth-shaped opening in the plate and multiple flexible tabs on the plate surface; wherein the opening is to be fitted onto the ring slot of the cylindrical jacket, and the flexible tabs are to press against the inner wall of the bumper.

The cylindrical jacket has a channel being formed on the inner surface which is to be fitted against the guide block of the sensor with a complementary construct. When installing the sensor, the guide block on the sensor is first fitted into the channel of the cylindrical jacket allowing the sensor to slide into the cylindrical jacket, and then on reaching the end the sensor is rotated by predetermined degrees to be engaged in the cylindrical jacket.

The cylindrical jacket also has a raised block on the external wall of the cylindrical jacket, which is to be fitted against the notch in the lower edge of the opening of the catch bracket. When the catch bracket is slid onto the ring slot of the cylindrical jacket, the catch bracket has to be turned by predetermined degrees, so that the raised block firmly engages against the notch of the catch bracket.

The secondary objective of the present invention is to provide a parking sensor that can be manually assembled by users; wherein the sensor has a signal socket with a shoulder piece on the fixed end to be fitted against the snap ring of the wire connector to form the signal connection.

The features and structure of the present invention will be more clearly understood when taken in conjunction with the accompanying figures.

### BRIEF DESCRIPTION OF THE DRAWINGS

FIG. 1 is a diagram of the architecture of the present invention;

FIG. 2 is an exploded view of the invention from another angle;

FIG. 3 is a perspective view of the cylindrical jacket from the rear;

FIG. 4 is a cross-sectional view of the sensor assembled and mounted on the vehicle bumper in accordance with the invention;

FIGS. 5a and 5b are the diagrams for assembling the sensor and the cylindrical jacket showing the position of the sensor in the cylindrical jacket before and after rotation to engage the sensor in the cylindrical jacket;

FIGS. 6 and 7 are the diagrams for assembling the catch bracket and the cylindrical jacket before and after rotation to engage the cylindrical jacket in the catch bracket.

### DETAILED DESCRIPTION OF THE PREFERRED EMBODIMENT

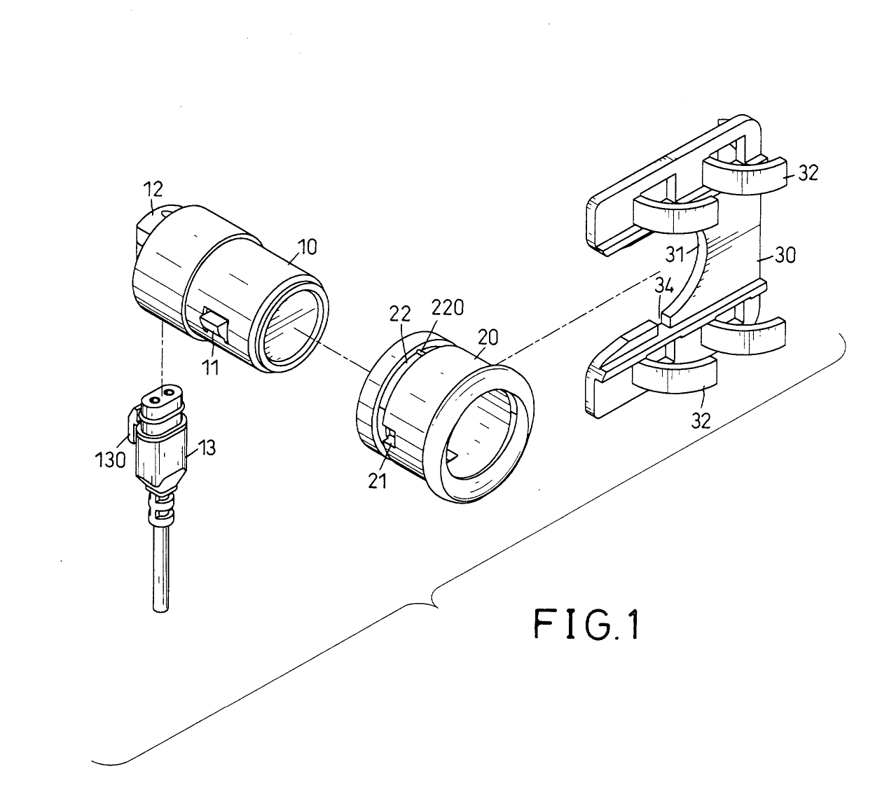

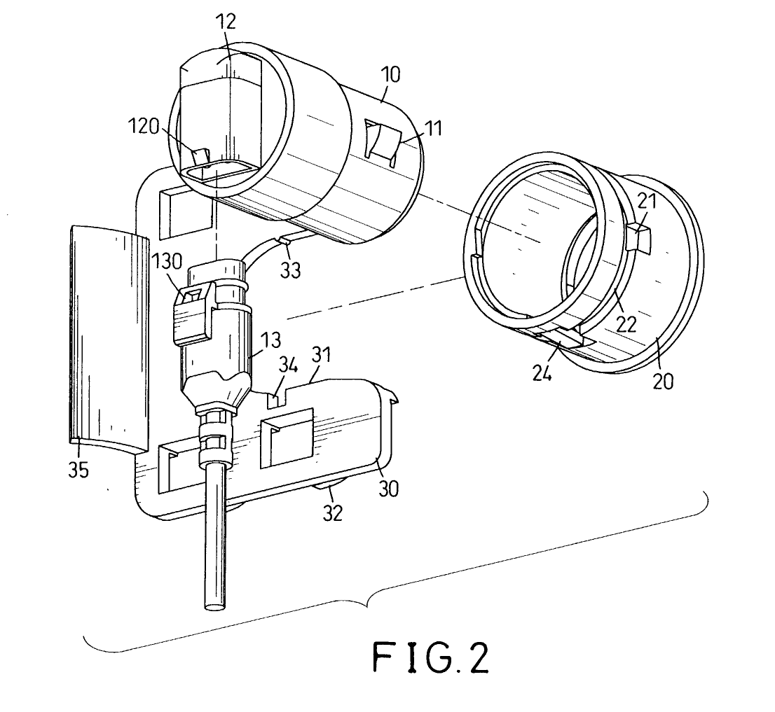

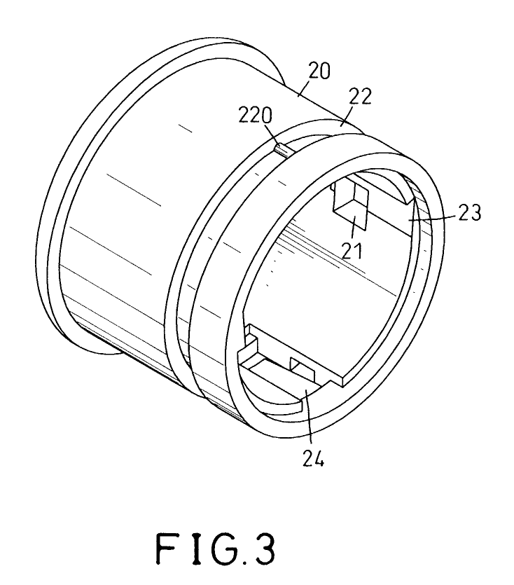

With reference to FIGS. 1, 2 and 3, the construction of the sensor and anchoring device mainly comprises a sensor (10), a cylindrical jacket (20) and a catch bracket (30).

The sensor (10) having a cylindrical shape has one flexible guide block (11) being formed on the external wall, and a signal socket (12) installed on the fixed end to connect to a wire connector (13); wherein the wire connection end of the signal socket (12) is formed by a shoulder piece (120) to be fitted against a snap ring (130) of the wire connector (13) to form the signal connection.

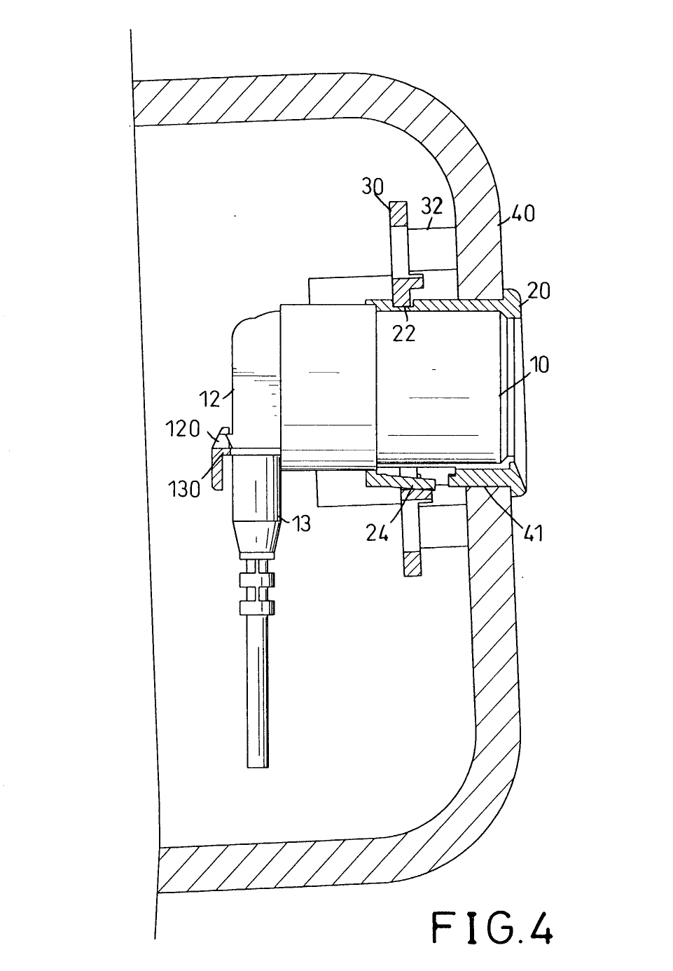

The cylindrical jacket (20), also having a hollow cylindrical body and being inserted into the predetermined position on the vehicle bumper (40) as seen in FIG. 4, has a catch slot (21) being formed on the external wall corresponding to the guide block (11) on the external wall of the sensor (10), a ring slot (22) being formed on the external wall with a bump (220) fixed at an appropriate position, a channel (23) being formed on the inner surface extending from the catch slot (21) to the open end, which is to be complementarily fitted against the guide block (11) on the external wall of the sensor (10), and a raised block (24) being formed at the bottom of the external wall of the jacket (20).

The catch bracket (30) has a mouth shape opening (31) in the plate with two sides of the opening (31) gradually expanding outward, a handle (35) being formed on the other side for holding with the hand, and multiple flexible tabs (32) being formed on the plate surface each having one end fixed to the plate and the other end extending out in an arched shape. When the opening (31) is to be fitted against the ring slot (22) on the cylindrical jacket (20) in mounting the catch bracket (30) onto the vehicle bumper (40), the flexible tabs (32) are pressed against the inner surface of the bumper (40), such that the sensor (10) can be firmly engaged in the cylindrical jacket (20) lodged on the bumper (40).

A first bump (33) and a notch (34) are respectively formed on the upper and lower flanged edges of the opening (31) of the catch bracket (30); wherein the first bump (33) is to be fitted against the second bump (220) on the ring slot (22); and the notch (34) corresponds to the raised block (24) on the external wall of the cylindrical jacket (20).

The construction of the anchoring device has been described, and the assembling procedures are to be described as follows:

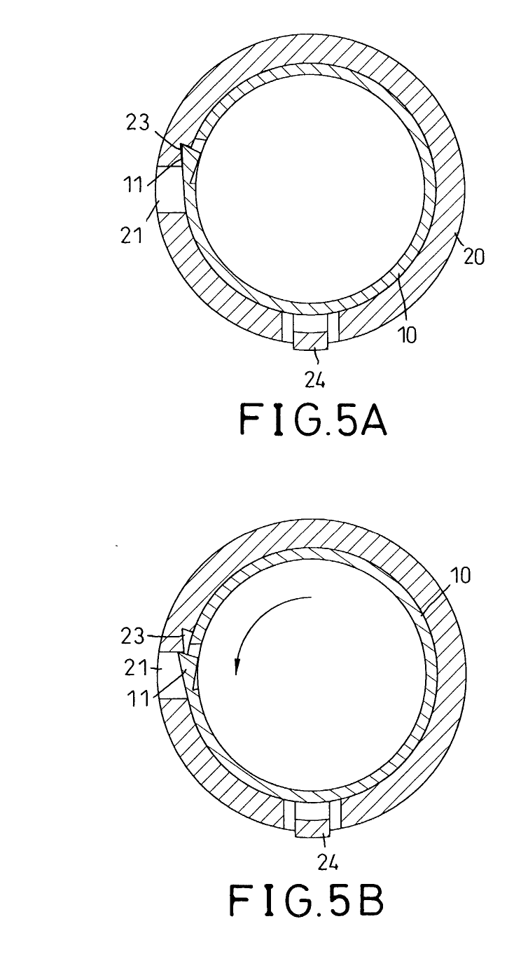

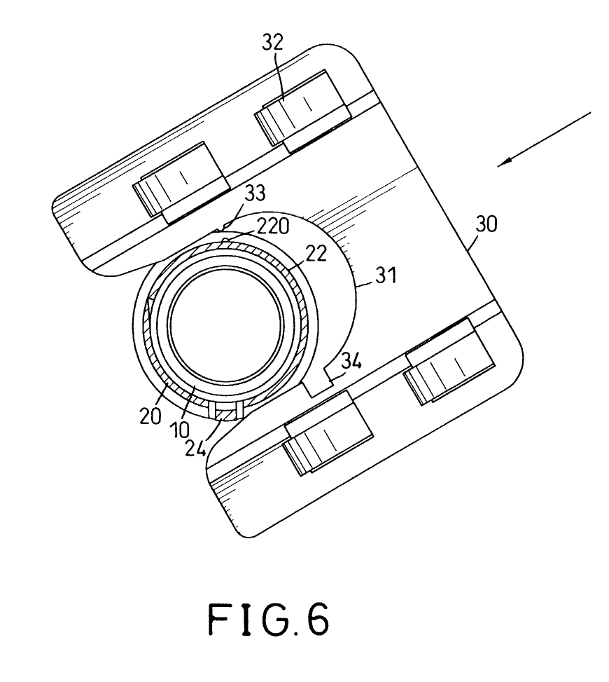

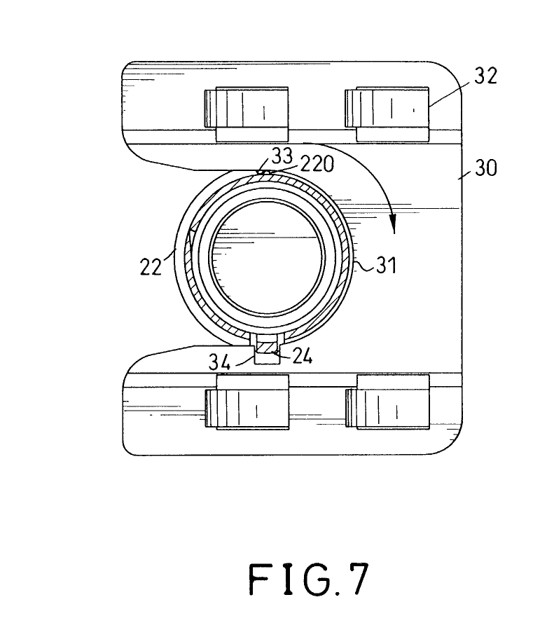

With reference to FIGS. 4, 5, 6 and 7, in assembling the sensor and anchoring device, the cylindrical jacket (20) is first inserted into the base hole (41) at the predetermined position on the car bumper (40), and then the sensor (10) is inserted into the cylindrical jacket (20) such that the guide block ( 1) of the sensor (10) is fitted in the channel (23) on the inner surface of the cylindrical jacket (20). When the sensor is pushed to the end, the sensor is turned counter-clockwise with predetermined degrees to allow the guide block (11) to be disengaged from the channel (23) and slid into the adjacent catch slot (21) forming an interlocking structure.

When the sensor (10) is engaged in the cylindrical jacket (20), then the catch bracket (30) is applied on the cylindrical jacket (20) allowing the opening (31) of the catch bracket (30) to slide into the ring slot (22) of the cylindrical jacket (20) at an inclined angle, but avoiding the second bump (220). On reaching the end, the catch bracket (30) is turned in a clockwise direction with predetermined degrees, such that the notch (34) in the lower edge of the opening (31) engages the raised block (24) of the cylindrical jacket (20). Such construction allows the raised block (24) to protrude outward; and the bump (33) on the upper edge of the opening (31) is stopped by the second bump (220) of the ring slot (22) in the cylindrical jacket (20), thus completing the installation of the sensor on the car bumper. After completing the assembly, the flexible tabs (32) of the catch bracket (30) are pressed against the wall of the bumper (40), and the sensor (10) is firmly fixed in the cylindrical jacket (20).

From the foregoing, it is clear that the assembling procedures are relatively simple: the cylindrical jacket (20) is first inserted into the base hole (41) of the bumper (40), and then the sensor (10) is rotatably fitted into the cylindrical jacket (20), and then the catch bracket (30) is slid onto the slot ring (22) of the cylindrical jacket (20) and fixed on the back side of the bumper (40). Also the length of the cylindrical jacket can be changed to suit the thickness of the steel frame of the rear bumper, such that the front end of the sensor is always salient from the rear bumper, thus avoiding any interference with the emission and reception of signals.

The foregoing description of the preferred embodiments of the present invention is intended to be illustrative only and, under no circumstances, should the scope of the present invention be so restricted.

What is claimed is:

1. A vehicle sensor and anchoring device, comprising: a sensor, a cylindrical jacket, and a catch bracket; wherein
the sensor is a cylindrical shaped body having a guide block on an external wall being fitted into the cylindrical jacket;
the cylindrical jacket having a ring slot and a catch slot being lodged in a vehicle bumper; and
the catch bracket forming a mouth-shaped opening and multiple flexible tabs on abase; wherein the opening being fitted against the ring slot of the cylindrical jacket and the flexible tabs being pressed against the vehicle bumper surface.

2. The vehicle sensor and anchoring device as claimed in claim 1, wherein a channel in an inner surface of the cylindrical jacket extending from the catch slot to an open end is to complement the corresponding guide block on the external wall of thesensor.

3. The vehicle sensor and anchoring device as claimed in claim 2, wherein the cylindrical jacket has a raised block on the external wall of the cylindrical jacket, which is to correspond to a notch in the lower edge of the opening on the catch bracket, allowing the catch bracket to slide onto the ring slot of the cylindrical jacket and the raised block to be firmly locked in the notch in the catch bracket after rotating by predetermined degrees.

4. The vehicle sensor and anchoring device as claimed in claim 3, wherein a first bump is formed on an upper flanged edge of the opening of the catch bracket, whereas a second bump is formed on the cylindrical jacket which is corresponds to the first bump on the catch bracket when assembled.

5. The vehicle sensor and anchoring device as claimed in claim 1, wherein a fixed end of the sensor has a signal socket to be fitted against a wire connector to establish the signal connection.

6. The vehicle sensor and anchoring device as claimed in claim 5, wherein the signal socket has a shoulder piece which is to be fitted against the snap ring on the wire connector to form an interlocking structure.
